(19) United States
(12) Patent Application Publication
(10) Pub. No.: US 2023/0402697 A1
(43) Pub. Date: Dec. 14, 2023

(54) Vehicle Cabin Portable Battery

(71) Applicant: Rivian IP Holdings, LLC, Irvine, CA (US)

(72) Inventor: Jonathan David Salerno, Newport, CA (US)

(21) Appl. No.: 17/835,563

(22) Filed: Jun. 8, 2022

(51) Int. Cl. H01M 50/249; H01M 50/262; H01M 10/42; F21L 4/08; H05B 47/155; H01M 50/284

(52) U.S. Cl. CPC H01M 50/249; H01M 50/262; H01M 10/4257; F21L 4/08; H05B 47/155; H01M 50/284

(57) ABSTRACT

A portable battery configured to be secured to a vehicle is disclosed. The portable battery includes a latch to secure it in the vehicle and electrical ports configured to provide power. The portable battery may also include a light source to provide ambient light which may be synchronized with the vehicle. The portable battery may charge a user device or the vehicle itself. The portable battery may also be charged from the vehicle.

### INTRODUCTION

When arriving at a destination, people may need a portable battery for charging devices such as a cell phone, smart device, or even their electric vehicle and an ambient light source to provide soft lighting while setting up a campsite or while performing other actions. These actions may occur while alternative light and charging sources are packed away or in an environment where there is no access to a power source for charging.

This description is of an illustrative environmental context only. It will be readily apparent to those of ordinary skill in the art that the principles of the present disclosure may equally apply in other environmental contexts.

### SUMMARY OF THE DISCLOSURE

Electric vehicles are becoming more common and the ability to charge portable electronic devices or the vehicle itself is important. Accordingly, described herein is a portable battery configured to latch into a vehicle (e.g., a vehicle cabin) for ease of access and charging. The portable battery comprises a latch configured to secure the device to the vehicle and electrical ports to provide power. The portable battery may include a battery module (e.g., comprising multiple battery cells). The battery module may, for example, have a capacity of at least 50 amp hours.

The portable battery may also include a light source. The light source may include a lens housing around the lower part of the portable battery and one or more emitters that provide diffuse light around the portable battery. Diffuse light is light that one which is spread over a wide area originating from an unconcentrated source as opposed to a point source. This light source may provide ambient light, as opposed to focused light, to create gentle light presence. The portable battery may communicate with a vehicle light controller so that the light source may be synchronized with other lights on the vehicle. Synchronizing may include adjusting the brightness, color, or power of the light source to match the other lights on the vehicle. The light source of the portable battery may also be synchronized with other portable batteries.

The portable battery may include electrical contacts to transfer (e.g., receive) electricity with the vehicle for charging purposes. When the portable battery is properly secured into the vehicle cabin with the latch, the electrical contacts are able to transfer electricity with the vehicle.

One or more buttons may be included on the portable battery. In some embodiments, the buttons may control the light source including powering the light on/off, adjusting the brightness, color, and/or any other settings adjustments of the light. In some embodiments, buttons may control the electrical ports including disabling or enabling power to each port. The buttons may comprise physical switches or capacitive switches.

A handle may be affixed to the surface of the portable battery, which when pulled, causes the latch to disengage the portable battery (e.g., from securement within a vehicle). The latch may be configured to prevent the portable battery from being disengaged based on whether a condition has been satisfied.

The vehicle may include a dock arranged in the cabin which include a latch that is used to secure the portable battery to the vehicle. The dock may be arranged on the center console.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1A is a front perspective view of a portable battery having a light that is powered on, in accordance with some embodiments of the present disclosure;

FIG. 1B is a rear perspective view of the portable battery of FIG. 1A with the light powered off, in accordance with some embodiments of the present disclosure;

FIG. 2 shows a vehicle console including a dock configured to receive the portable battery therein and to secure the portable battery;

FIG. 3 is a partial bottom perspective view of a portable battery, in accordance with some embodiments of the present disclosure;

FIG. 4A is a partial cross-sectional view of a portable battery, in accordance with some embodiments of the present disclosure;

FIG. 4B is a partial cross-sectional view of a lighting housing, in accordance with some embodiments of the present disclosure;

FIG. 5 is a block diagram of components of a portable battery and lighting device, in accordance with some embodiments of the present disclosure;

FIG. 6 is a block diagram of components of a vehicle having a portable battery coupled within a cabin, in accordance with some embodiments of the present disclosure;

FIG. 7A shows a flowchart of an illustrative process to synchronize lighting on a portable battery with vehicle lighting by checking the connections, in accordance with some embodiments of the present disclosure;

FIG. 7B shows a flowchart of an illustrative process to synchronize lighting on a portable battery with vehicle lighting by checking distance between the devices, in accordance with some embodiments of the present disclosure;

FIG. 8 shows a flowchart of an illustrative process to charge a vehicle battery from a portable battery, in accordance with some embodiments of the present disclosure;

FIG. 9 shows a flowchart of an illustrative process to power a vehicle from a portable battery, in accordance with some embodiments of the present disclosure;

FIG. 10 is a front view of a portable battery;

FIG. 11 is a back view of the portable battery of FIG. 10;

FIG. 12 is a left-side view of the portable battery of FIG. 10;

FIG. 13 is a right-side view of the portable battery of FIG. 10;

FIG. 14 is a top view of the portable battery of FIG. 10;

FIG. 15 is a bottom view of the portable battery of FIG. 10; and

FIG. 16 is a front-left side perspective view of the portable battery of FIG. 10.

### DETAILED DESCRIPTION

This disclosure is directed towards a portable battery device that can be coupled inside a vehicle cabin. When the portable battery is secured inside the vehicle cabin, the vehicle may charge it. The portable battery may be used to charge other electronic devices or the vehicle itself. The portable battery may include a lighting module that proves ambient light that may be synchronized with the vehicle's lighting system.

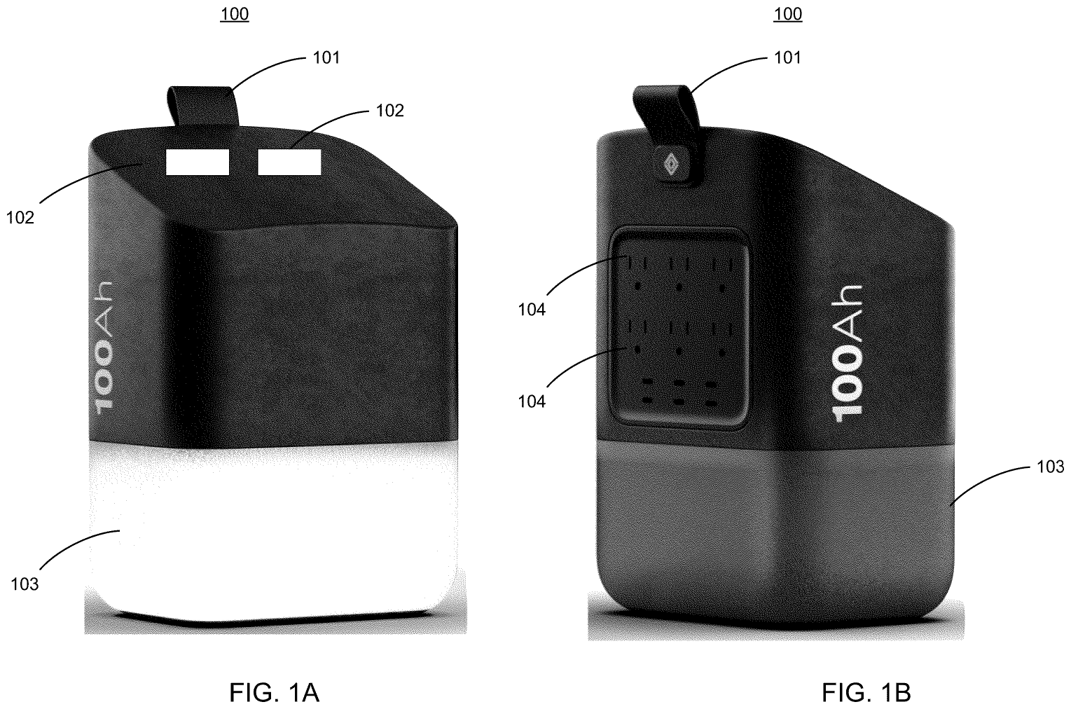

FIG. 1A is a front perspective view of a portable battery 100 having a light 103 that is powered on, in accordance with some embodiments of the present disclosure. Portable battery 100 is a removable device that can be configured to be secured to a vehicle for charging. For example, the portable battery may be secured to the center console, vehicle cabin, in a door, under a seat, in or adjacent to a storage compartment, a trunk, exterior the cabin and on an exterior portion of the body of the vehicle, and the like.

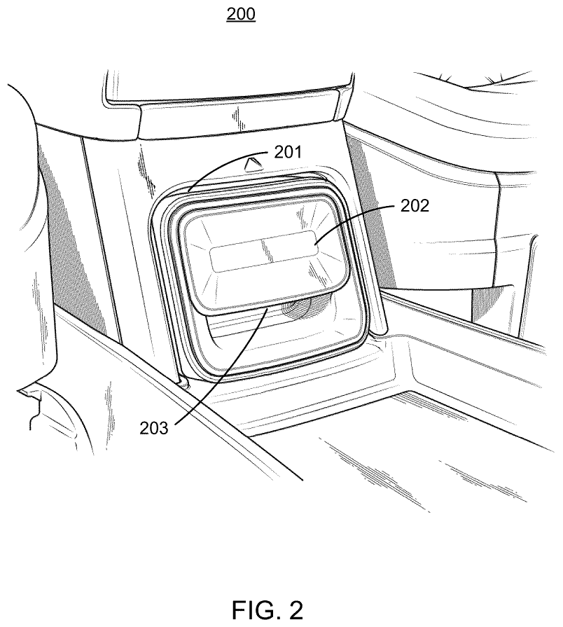

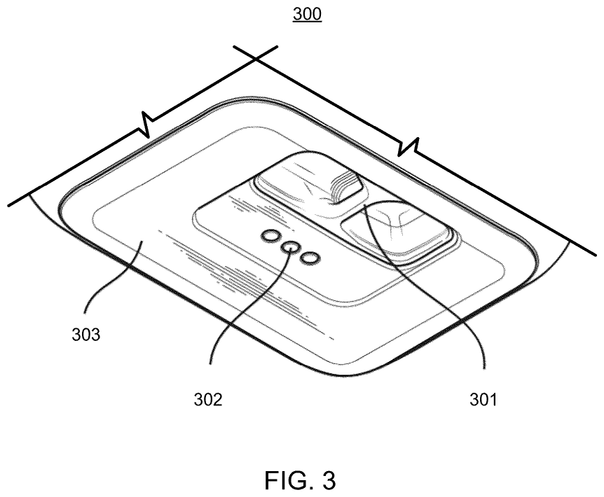

Handle 101 may be used to release and lift up the portable battery 100. When handle 101 is pulled, portable battery 100 is configured to unlatch from the vehicle cabin. In some embodiments, handle 101 may include a sensor which determines whether the handle is being pulled by a user. In some embodiments, the sensor may be an electrical sensor which detects the user pulling on handle 101 to allow the latch securing portable battery 100 to the vehicle to be released. In some embodiments, the handle 101 may mechanically cause the portable battery 100 to be released. In some embodiments, handle 101, or is configured to determine whether a user is intentionally triggering release of the portable battery to avoid accidental release during an accident and avoid portable battery 100 from becoming loose within the cabin. The latch may prevent the portable battery from being disengaged based on whether a condition is satisfied. Further details of the latching mechanism are described in FIG. 2 and FIG. 3.

Buttons 102, in some embodiments, control operation of the light 103, including powering the light on/off, adjusting the brightness, color, and/or any other settings adjustments of the light. In some embodiments, buttons 102 control operation of the electrical ports, including disabling or enabling power to each of the ports (e.g., to disable or enable charging capability). In some embodiments, the buttons 102 may implement any of the above embodiments through capacitive switches, physical switches, or wireless communication.

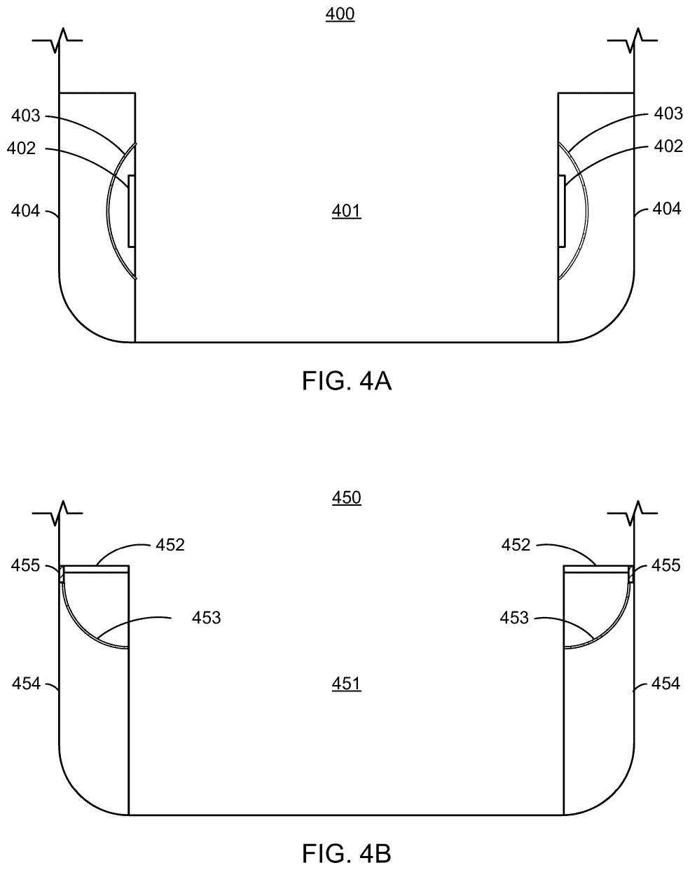

Light 103 is configured to provide ambient light and is arranged on the lower exterior surface of portable battery 100. In some embodiments, light 103 may be softened through use of a diffuser. In some embodiments, light 103 is adapted to emit light in a direction away from the top of and towards the bottom of portable battery 100. In some embodiments, light 103 extends around the entire circumference of portable battery 100 (i.e., the front, back, and lateral sides). In some embodiments, light 103 includes an aperture adapted to disperse the light. Light 103 may include one or more light sources (e.g., light-emitting diodes (LEDs)) adapted to emit light in the direction outwards or towards the bottom of portable battery 100. Arrangements of light 103 are described in further detail in connection with FIG. 4A and FIG. 4B. As illustrated in FIG. 1A, handle 101 and buttons 102 are located on top of portable battery 100, but it is to be understood that they may be located elsewhere on the portable battery, such as on the sides of the unit.

FIG. 1B is a rear perspective view of the portable battery 100 of FIG. 1A with the light 103 powered off, in accordance with some embodiments of the present disclosure. As shown, the rear of portable battery 100 includes electrical outlets 104 that provide a location for a plug to be inserted to charge a portable device such as a cell phone or any other device requiring charge. In some embodiments, electrical outlets 104 may be 2 prong outlets, 3 prong outlets, USB outlets, or any other suitable outlets for charging user devices. In some embodiments, electrical outlets 104 may be configured to be turned on or off by way of buttons 102. While electrical outlets 104 are located on the back of portable battery 100 in FIG. 2, it is to be understood that they may be located elsewhere on the portable battery, such as on the sides, front, or top of the unit.

FIG. 2 shows a vehicle console 200 including a dock 201 configured to receive the portable battery 202 therein and to secure the portable battery 202. In some embodiments, portable battery 202 corresponds to portable battery 100 of FIG. 1A and FIG. 1B. Handle 203 may be configured to remove portable battery 100 from dock 201. While handle 101 of FIGS. 1A and 1B is shaped as a tab, handle 203 of FIG. 2 overhangs a recess such that it can be grabbed from behind to pull portable battery 202 out of dock 201.

While the dock 201 is positioned in the vehicle console 200 (e.g., a front center console), it will be appreciated that, in some embodiments, the dock 201 may be positioned in other locations of a vehicle, such as in a door, under a seat, in or adjacent to a storage compartment, a trunk, exterior the cabin, on an exterior portion of the body of the vehicle, and the like. Similarly, dock 201 may be configured, in some embodiments, to secure the portable battery 100 in different orientations such that light 103 is oriented to face various locations to provide additional lighting to, for example, the foot well of the front row, the foot well of the second row, the trunk, outside the vehicle, or any other suitable locations.

FIG. 3 is partial bottom perspective view of a portable battery 300, in accordance with some embodiments of the present disclosure. In some embodiments, portable battery 300 corresponds to portable battery 100 of FIGS. 1A and 1B or portable battery 202 of FIG. 2. Bottom 303 of portable battery 300 includes latch 301 and electrical contacts 302. In some embodiments, bottom 303 corresponds to the bottom of portable battery 100 of FIGS. 1A and. 1B or the bottom of portable battery 202 of FIG. 2. In some embodiments bottom 303 is adapted to support the portable battery 300 in a predetermined orientation while resting on a surface, such as an upright orientation.

In some embodiments, the bottom 303 includes latch 301. The latch 301 may be part of a fastening mechanism adapted to secure the portable battery 300 to a vehicle, such as within dock 201 of FIG. 2. In some embodiments, latch 301 is also adapted to connect to latching devices, such as carabiners, clips, and other mechanism used for connecting components, including camping equipment, together for hanging the portable battery 100. In some embodiments, if desired another latch 301 may be included on the top of portable battery 300 and may be adapted for hanging the portable battery 300. In various embodiments, the latch 301 is configured to secure the portable battery 300 within a vehicle, such as within vehicle console 200 of FIG. 2. As such, the latch 301 is configured to secure the portable battery 300 and ensure the portable battery 300 remains secured regardless of vehicle movements (e.g., acceleration, deceleration, sudden stops, sudden movements from collisions, sudden turns, vertical and/or horizontal movements, etc.) and vehicle orientations (e.g., rotated positions, tilted positions, other positions resulting from rock crawling, positions resulting from a rollover, and the like). In some embodiments, the latch 301 may interface with a power actuator in the dock 201. Latch 301 may be released by a user interacting with handle 101 or handle 203 which may either mechanically, electrically, or wirelessly release latch 301.

In some embodiments, bottom 303 includes electrical contacts 302 that are adapted to receive electricity from a vehicle for charging a battery of the portable battery 300. In some embodiments, the electrical contacts 302 are further configured to facilitate communication between the portable battery 300 and a controller of the vehicle, such as a power or light system controller or the like. The combination of the position and orientation of the portable battery 300 along with the connection to the latch 301 can help contribute to ensuring a proper connection between the electrical contacts 302 and the dock 201 for proper charging of the portable battery 300 or communication with the vehicle.

FIG. 4A is a partial cross-sectional view of a lighting housing on a portable battery 400, in accordance with some embodiments of the present disclosure. In some embodiments, portable battery 400 corresponds to portable battery 100 of FIGS. 1A and 1, portable battery 202 of FIG. 2, or portable battery 300 of FIG. 3. In some embodiments, lens housing 404 corresponds to lighting housing 103 of FIGS. 1A and 1B. Storage enclosure 401 may hold one or more battery cells of a battery module of portable battery 400.

Portable battery 400 comprises a lens housing 404 which wraps around the circumference of portable battery 400. Lens housing 404 contains light emitter 402 which may be, for example, an LED. In some embodiments, light emitter 402 is located internal to portable battery 400 and is positioned around the outer sides of the storage enclosure 401. In some embodiments, light emitter 402 may be a single light strip wrapped around the entire circumference of storage enclosure 401 or multiple light emitters spaced apart. In some embodiments, lens housing 404 is configured to create a soft, ambient light. If lens housing 404 does not sufficiently soften or diffuse the light, diffuser 403 be included between light emitter 402 and lens housing 404. Depending on the brightness, spacing, size, and other configurations of emitter 402, different diffusers may be chosen for diffuser 403.

FIG. 4B is a partial cross-sectional view of a lighting housing on portable battery 450, in accordance with some embodiments of the present disclosure. In some embodiments, portable battery 450 corresponds to portable battery 100 of FIG. 1A and FIG. 1B, portable battery 202 of FIG. 2, and portable battery 300 of FIG. 3. In some embodiments, lens housing 454 corresponds to lighting housing 103 of FIG. 1A and FIG. 1B. Storage enclosure 451 may hold battery cells for portable battery 450.

Portable battery 450 comprises lens housing 454 which wraps around the circumference of portable battery 450. Lens housing 454 contains light emitter 452 which may be, for example, an LED. In some embodiments, light emitter 452 is located internal to battery 450 and is positioned around the upper portion of storage enclosure 451. In some embodiments light emitter 452 may be a single light strip wrapped around the entire circumference of storage enclosure 451 or multiple light emitters spaced apart. In some embodiments, lens housing 454 is configured to create a soft, ambient light. If lens housing 454 does not sufficiently soften or diffuse the light, diffuser 453 may be included between light emitter 452 and lens housing 404. Shield 455 blocks light from emitter 452 from coming directly out to lighting housing 454, and instead deflects it down so that the light may be diffused by light diffuser 453. Depending on the brightness, spacing, size, and other configurations of emitter 452, different diffusers may be chosen for diffuser 453. Shield 455 may comprise a mirror which reflects the light from light emitter 452 and focus it towards diffuser 453 or an opaque material such as plastic which simply blocks the light.

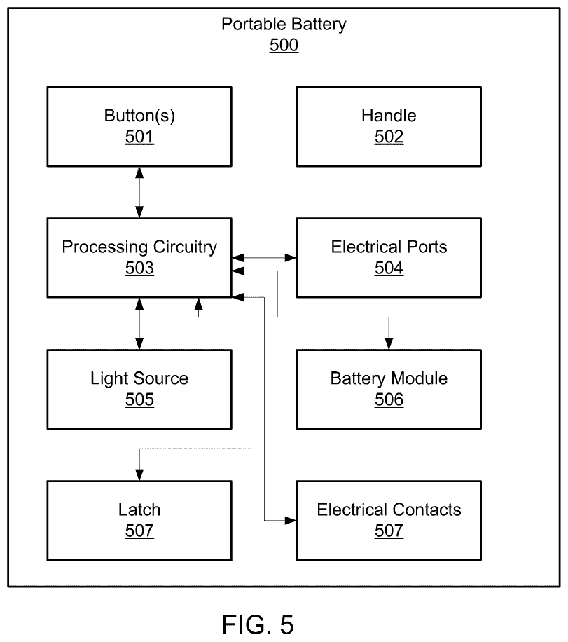

FIG. 5 is a block diagram of components of a portable battery 500, in accordance with some embodiments of the present disclosure. In some embodiments, portable battery 500 corresponds to portable battery 100 of FIGS. 1A and. 1B, portable battery 202 of FIG. 2, portable battery 300 of FIG. 3, portable battery 400 of FIG. 4A, or portable battery 450 of FIG. 4B. Portable battery 500 may comprise buttons 501, handle 502, processing circuitry 503, electrical ports 504, light source 505, battery module 506, latch 507, and electrical contacts 508. Latch 507 may be designed to secure the portable battery 500 to a dock such as dock 201 of FIG. 2 with electrical contacts 508 lined up to allow for charging of the battery module 506. Handle 506 may be used to release portable battery 500 from dock 201. In some embodiments, handle 506 interacts with an actuator of latch 507 to release portable battery 500 from dock 201 when handle 506 is touched, pulled, or otherwise activated. In some embodiments, portable battery 500 can only be released from dock 201 based on whether a condition is satisfied (e.g., the vehicle is moving slowly (e.g., below a speed threshold such as 35 mph), the vehicle is stopped, and/or the vehicle is in a parked position). For example, latch 201 or an associated actuator prevent portable battery 500 from being release when the condition is not satisfied. Light source 505 provides an ambient light as described above.

The portable battery 500 may comprise processing circuitry 503 which may comprise a processor and memory. Processing circuitry 503 may comprise a hardware processor, a software processor (e.g., a processor emulated using a virtual machine), or any combination thereof. Memory included in processing circuitry 503 may comprise hardware elements for non-transitory storage of commands or instructions, that, when executed by processing circuitry 503, cause processing circuitry 503 to operate portable battery 500 in accordance with embodiments described above and below. The memory in processing circuitry 503 may further store information about user configurations of portable battery 500 and light source 505. This stored information may be based on user inputs from button(s) 501, an interactive screen in the vehicle communicating with processing circuitry 503 of the portable battery, synchronizing information with vehicle lights or other information from the vehicle, synchronizing information from other portable batteries or portable speakers, and/or any other suitable methods for configuring the portable battery 500. Processing circuitry 503 may be communicatively connected to components of a vehicle via one or more wires, electrical contacts 508, or via wireless connection.

Processing circuitry 503 may receive information from latch 507 and electrical contacts 508 to determine if the portable battery 500 is correctly positioned within dock 201 to begin charging operations. Processing circuitry 503 may also receive information from battery module 506 to determine the power level of portable battery 500 and based on the information configure electrical contacts 508 to stop charging operations when battery module 506 is fully charged.

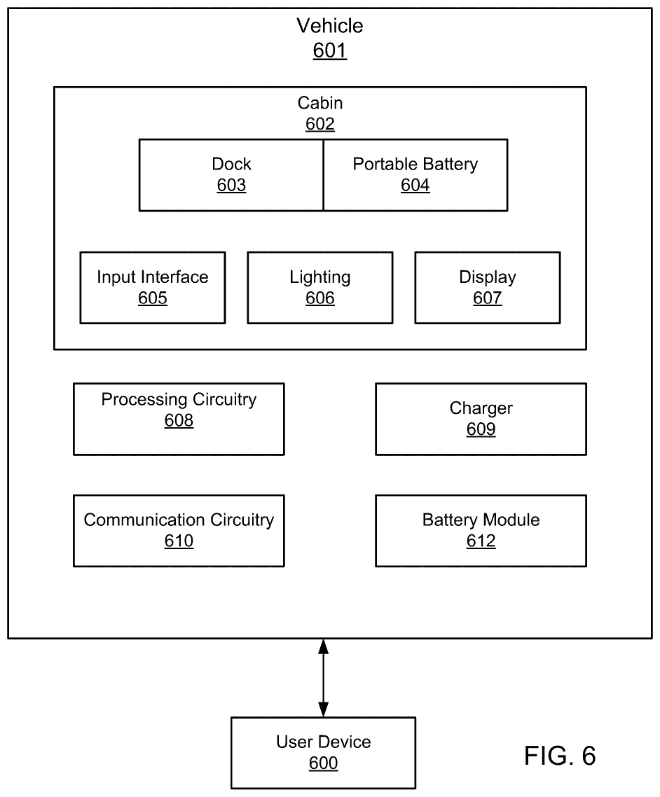

FIG. 6 is a block diagram of components of a vehicle 601 having a portable battery 604 coupled within a cabin 602, in accordance with some embodiments of the present disclosure. In some embodiments, portable battery 604 corresponds to portable battery 100 of FIGS. 1A and. 1B, portable battery 202 of FIG. 2, portable battery 300 of FIG. 3, portable battery 400 of FIG. 4A, portable battery 450 of FIG. 4B, or portable battery 500 of FIG. 5. In some implementations of the present disclosure, the vehicle 601 may be an electric vehicle such as a car (e.g., a coupe, a sedan, a truck, an SUV, a bus), a motorcycle, an aircraft (e.g., a drone), a watercraft (e.g., a boat), or any other type of vehicle.

Vehicle 601 may include a cabin 602 containing a dock 603 configured to receive the portable battery 604. In some embodiments, dock 603 may correspond to dock 201 of FIG. 2. In some embodiments, multiple portable batteries 604 are utilized and dock 603 is configured to receive any one of the portable batteries 604. In some embodiments, dock 603 is configured to receive other types of portable devices such as a portable speaker (e.g., having a similar form factor capable of interfacing with dock 603). Additionally, within the vehicle cabin 602 there may be an input interface 605, vehicle lighting 606, and display 607. Input interface 605 may be one or more buttons, a touch screen, or any other user interface that allows a user to input configurations for portable battery 604. For example, a user may be able to configure the electrical ports on portable battery 604 on/off, the light of portable battery 604 on/off, and synchronize the light of portable battery 604 with the lighting 606 of the vehicle 601. Display 607 may be configured to show information about how portable battery 604 is configured, including current charge level, a charging schedule, light brightness, which ports on the battery module are on/off, and any other suitable configurations.

Processing circuitry 608 may be communicatively connected to battery module 612 which may be configured to provide power to one or more of the components of vehicle 601 during operation. Battery module 612 may comprise an electric battery which may include one or more battery cells. In some embodiments, the battery module 612 may be a 180 kWh battery pack or a 135 kWh battery pack. Battery module 612 may interface with on-board charger 609 to manage the flow of electricity to portable battery 604 (e.g., to perform DC-DC conversion for charging), and any other suitable components. Battery module 612 may be configured to manage charging of portable battery 604, measuring one or more characteristics of portable battery 604, providing power to components of vehicle 601, communicating with charger 609, any other suitable actions, or any combination thereof. Battery module 612 may include, for example, electrical components (e.g., switches, bus bars, resistors, capacitors), control circuitry (e.g., for controlling suitable electrical components), and measurement equipment (e.g., to measure voltage, current, impedance, frequency, temperature, or another parameter). Battery module 612 may provide charge status information to processing circuitry 608. Charge status information includes, for example, charge level, whether the portable battery 604 is being charged, charging current, charging voltage, charging mode, and whether a charging fault exists. User device 600 may then be plugged into portable battery 604 to receive charge. User device 600 may be a user's smartphone or any other personal device which can communicate directly or indirectly with the vehicle via server or the internet.

Processing circuitry 608 may be communicatively connected to display 607 by way of communication circuitry 610. Display 607 may be located at a dashboard of vehicle 601 and/or a heads-up display at a windshield of vehicle 601. For example, display 607 may comprise an LCD display, an OLED display, an LED display, or any other type of display.

In some embodiments, processing circuitry 608 comprises a vehicle light controller or is implemented as part of a vehicle light controller. The vehicle light controller may transmit signals to portable battery 500 to turn on and off light source 505. For example, in response to a vehicle door being opened, the vehicle light controller may transmit a signal to portable battery 505 to turn on light source 505. As another example, the vehicle light controller may transmit a signal to portable battery 500 to turn on light source 505 in response to a user input (e.g., inputted using input interface 605).

It should be appreciated that FIG. 6 only shows some of the components of vehicle 601, and it will be understood that vehicle 601 also includes other elements commonly found in vehicles (e.g., electric vehicles), e.g., a motor, brakes, wheels, wheel controls, turn signals, windows, doors, etc.

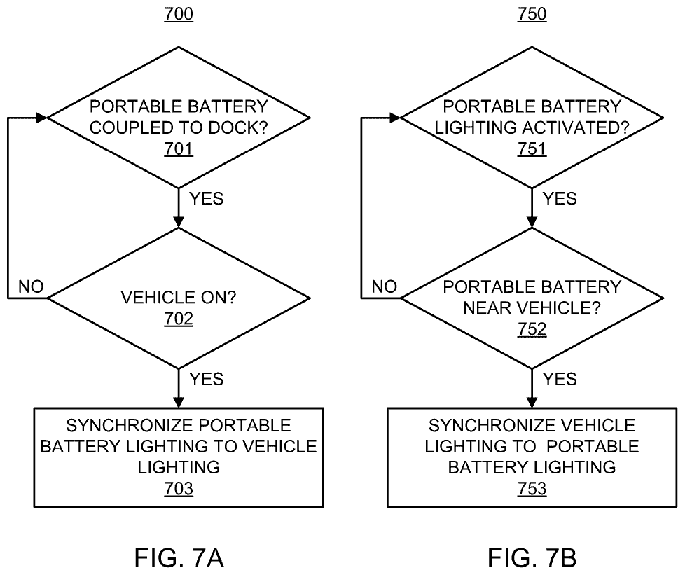

FIG. 7A shows a flowchart of an illustrative process 700 to synchronize lighting on a portable battery with vehicle lighting by checking the connections, in accordance with some embodiments of the present disclosure. In some embodiments, process 700 is executed by processing circuitry 503 of portable battery 500 of FIG. 5. In some embodiments, the execution of process 700 is distributed across processing circuitry of multiple devices (e.g., portable battery 604 and vehicle 601).

At 701, processing circuitry 503 determines whether portable battery 604 is coupled to dock 603. In some embodiments, processing circuitry 503 may determine this by checking the connection of electric contacts 302 of portable battery 604 to corresponding contacts on dock 603, determining whether charger 609 is currently sending power to portable battery 604, determining whether processing circuitry 608 or communication circuitry 610 of vehicle 601 is communicating with processing circuitry 503 of portable battery 604, or any other suitable technique. When portable battery 604 is not coupled to dock 603, then process 700 may terminate or wait until portable battery 604 is coupled to dock 603.

At 702, processing circuitry 503 determines whether vehicle 601 is currently on. In some embodiments, portable battery 604 may only be synced with vehicle 601 when it is on. If vehicle 601 is determined to not be on (“NO” at 702), the connection between portable battery 608 and vehicle 601 is checked again. In some embodiments, if vehicle 601 is determined to not be on (“NO” at 702), process 700 is terminated.

If vehicle 601 is determined to be on (“YES” at 702), the portable battery lighting is synchronized with the vehicle lighting 606 at 703. In some embodiments, synchronizing the lighting may mean that if the vehicle lights 606 are on, then the light source 505 on portable battery 604 is also turned on. In some embodiments, the light source 505 on the portable battery 604 are synchronized with the configurations of the vehicle lighting, such as color, brightness, speed of pulsing, or any other suitable lighting configurations.

FIG. 7B shows a flowchart of an illustrative process 750 to synchronize lighting on a portable battery with vehicle lighting by checking distance between the devices, in accordance with some embodiments of the present disclosure. In some embodiments, process 750 is executed by processing circuitry 503 of portable battery 500 of FIG. 5. In some embodiments, the execution of process 750 is distributed across processing circuitry of multiple devices (e.g., portable battery 604 and vehicle 601).

At 751, processing circuitry 503 determines whether the portable battery lighting has been activated. In some embodiments, processing circuitry 503 may determine this by communicating with button(s) 501 or light source 505. In some embodiments, processing circuitry 503 may determine this by determining whether portable battery 604 is turned on. If the portable battery lighting is determined to not be activated (“NO” at 751), process 750 may be terminated or wait until the portable lighting is activated.

If the portable battery lighting is determined to be activated (“YES” at 751), processing circuitry 503 determines whether portable battery 604 is currently near vehicle 601 at 752. Processing circuitry 503 may determine this by checking the connection between communication circuitry 610 of vehicle 601 and portable battery 604, using GPS location, checking a wireless connection, or any other suitable method for checking locations of the devices. If portable battery 604 is determined to not be near vehicle 601 (“NO” at 752), process 750 returns to step 751. In some embodiments, process 750 may be terminated.

If portable battery 604 is determined to be near the vehicle (“YES” at 752), the vehicle lighting 606 and lighting on portable battery 604 are synchronized at 753. In some embodiments, the light source 505 on the portable battery 604 is synchronized with the configurations of the vehicle lighting, such as color, brightness, speed of pulsing, or any other suitable lighting configurations. In some embodiments, adjusting the configuration of light source 505 on the portable battery 604 will cause corresponding adjustments to the vehicle lighting. For example, processing circuitry 503 may transmit (e.g., wirelessly) a light source status signal to a vehicle light controller of vehicle 601 to enable synchronization of other lights associated with vehicle 601. The light source status signal may indicate, for example, whether light source 505 is on or off, a color of light source 505, a brightness of light source 505, speed of pulsing, any other light source status information, or any combination thereof.

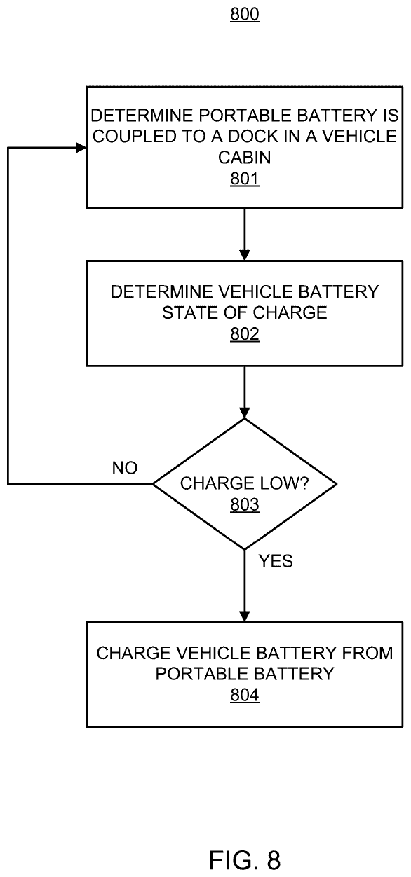

FIG. 8 shows a flowchart of an illustrative process 800 to charge a vehicle battery from a portable battery, in accordance with some embodiments of the present disclosure. In some embodiments, process 800 is executed by processing circuitry 608 of vehicle 601 of FIG. 6. In some embodiments, the execution of process 800 is distributed across processing circuitry of multiple devices (e.g., vehicle 601 and portable battery 604 and).

At 801, processing circuitry 608 determines that portable battery 604 is coupled to dock 603 in vehicle cabin 602. In some embodiments, processing circuitry 608 may determine this by checking the connection of dock 603 with electrical contacts of portable battery 604, determining whether processing circuitry 608 or communication circuitry 610 of vehicle 601 is able to communicate with processing circuitry 503 of portable battery 604, or any other suitable technique.

At 802, processing circuitry 608 determines the state of charge of vehicle battery 612. In some embodiments, processing circuitry 608 may determine this by retrieving this value from memory or communicating with battery module 612 or charger 609. At 803, if the state of charge is determined to not be low (“NO” at 803), processing circuitry 608 continues to monitor the coupling of portable battery 604 to dock 603 and the vehicle battery 612 state of charge.

If the state of charge is determined to be low (“YES” at 803), portable battery 604 may begin charging vehicle battery 612 at 804. Portable battery 604 may charge vehicle 601 by transferring electricity through electrical contacts 508, electrical ports 504, or any other suitable connection. In some embodiments, the charging is performed in response to processing circuitry 608 instructing charger 609 to begin charging the vehicle battery 612 from portable battery 604. In some embodiments, charger 609 is a bidirectional DC-DC charger capable of delivering current from the vehicle battery 612 to portable battery 604 and current from portable battery 604 to vehicle battery 612.

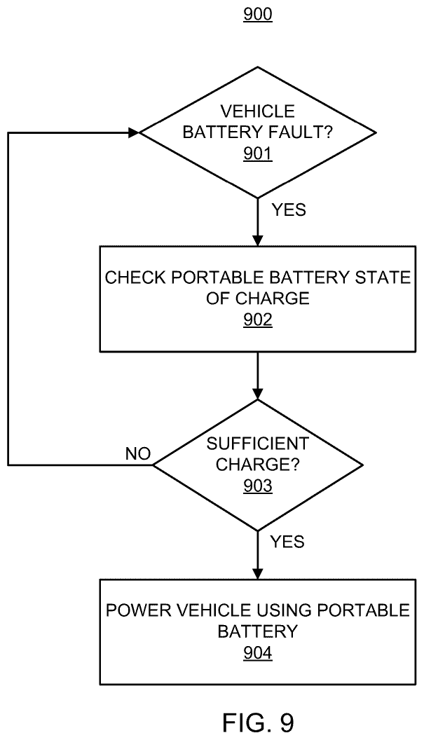

FIG. 9 shows a flowchart of an illustrative process 900 to power a vehicle from a portable battery, in accordance with some embodiments of the present disclosure. In some embodiments, process 900 is executed by processing circuitry 608 of vehicle 601 of FIG. 6. In some embodiments, the execution of process 900 is distributed across processing circuitry of multiple devices (e.g., vehicle 601 and portable battery 604).

At 901, processing circuitry 608 determines whether there is a vehicle battery fault. In some embodiments, processing circuitry 608 may determine this by communicating with battery module 612 or checking a vehicle diagnostic trouble code. If vehicle battery 612 is determined to not have a fault, process 900 may terminate or wait until a fault is determined.

If vehicle battery 612 is determined to have a fault (“YES” at 901), processing circuitry 608 may check the state of charge of portable battery 604. In some embodiments, processing circuitry 608 may determine this by communicating with the portable battery 605. If the state of charge of portable battery 604 is determined to not be sufficient to run the vehicle (“NO” at 903), process 800 may terminate or return to step 901.

If the state of charge of portable battery 604 is determined to be sufficient to run the vehicle (“YES” at 903), processing circuitry 608 may cause vehicle 601 to be powered using battery 506 instead of battery 612. This bypasses the fault state of battery 612 and allows the vehicle to continue to operate (e.g., at a reduced power state until the vehicle can be driven home or to a service location). This change in battery source may be displayed on display 607 to alert the driver that an error occurred with battery 612 and an alternate battery source is being used. Portable battery 604 may power vehicle 601 while secured in dock 603 or by any other suitable means (e.g., by connecting a power cable associated with the vehicle to one of electrical ports 504).

### Design Aspects

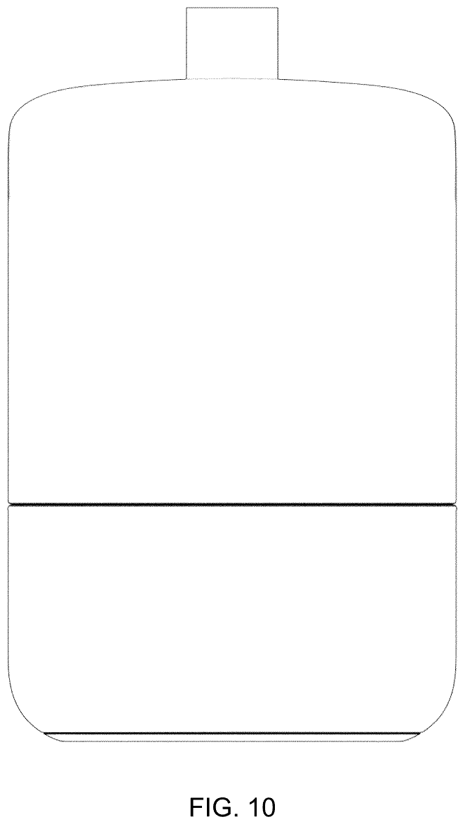

The following describes an illustrative design of a portable battery, in accordance with the present disclosure. In some embodiments, FIGS. 10-16 illustrate the ornamental design of a portable battery as shown in FIGS. 1A, 1, and 3 and as described above.

In some embodiments, the present disclosure is directed to a new, original, and ornamental design for a portable battery, of which the following is a specification, reference being had to the accompanying drawings (i.e., FIGS. 10-16), forming a part thereof. The portable battery may, for example, be intended for use within a vehicle such as within a vehicle cabin. Applicant reserves the right to claim any part, portion, element, and/or combination thereof of the disclosed design, including to replace any part, portion, element, and/or combination thereof with a broken line boundary to disclaim such part, portion, element, and/or combination thereof of the disclosed design.

FIG. 10 is a front view of a portable battery;

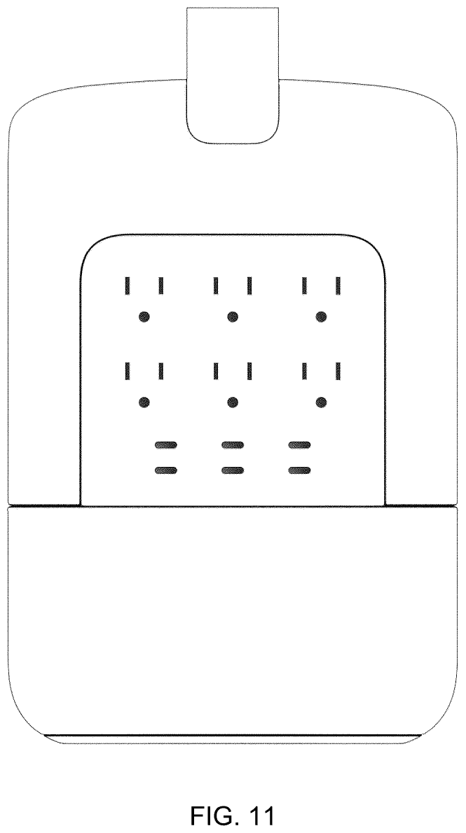

FIG. 11 is a back view of the portable battery;

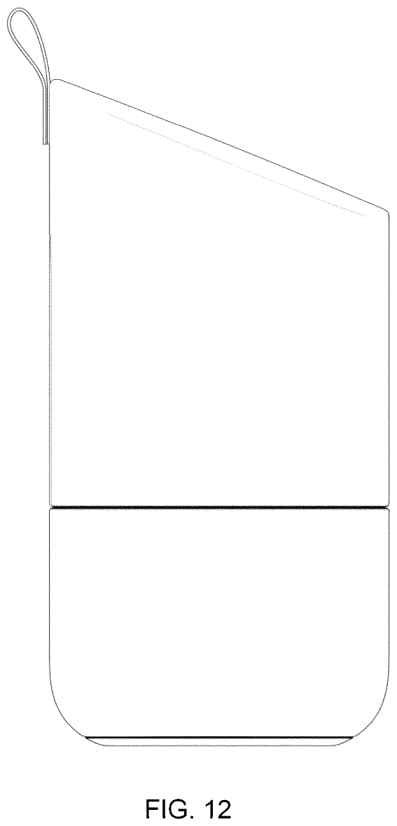

FIG. 12 is a left-side view of the portable battery;

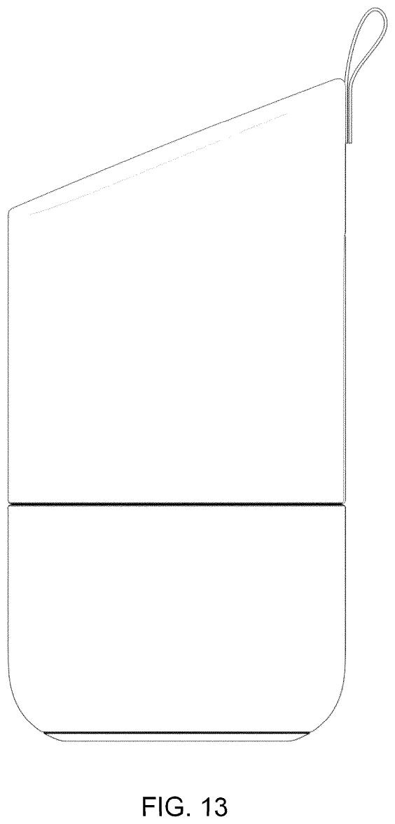

FIG. 13 is a right-side view of the portable battery;

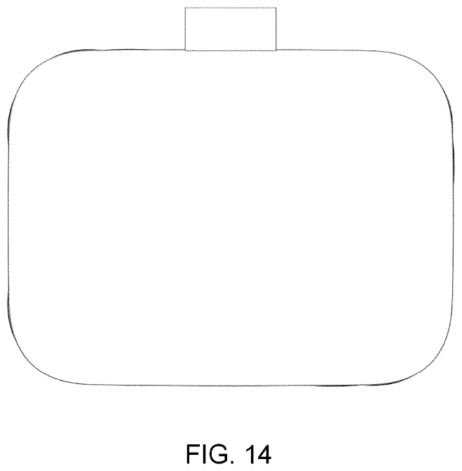

FIG. 14 is a top view of the portable battery and handle;

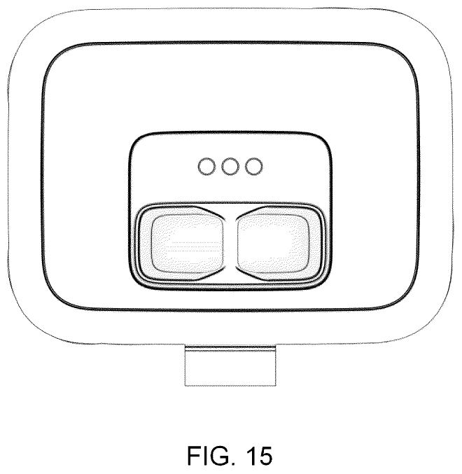

FIG. 15 is a bottom view of the portable battery; and

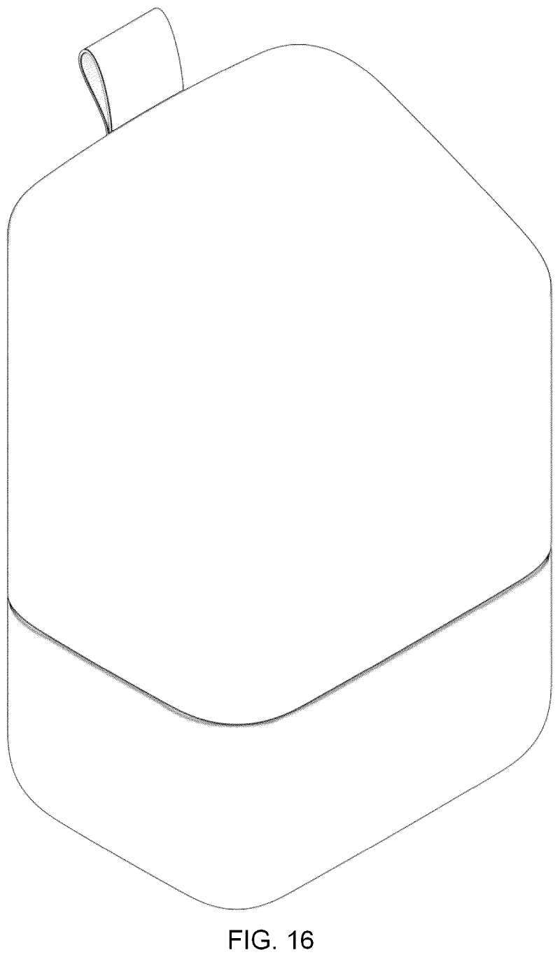

FIG. 16 is a front-left side perspective view of the portable battery.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A portable battery comprising:
a latch configured to secure the portable battery within a vehicle; and
one or more electrical ports configured to provide power.

2. The portable battery of claim 1, further comprising:
a light source configured to emit light;
a lens housing surrounding a lower exterior surface of the portable battery; and
one or more light emitters internal to the light source and configured to emit light towards an interior surface of the lens housing to provide diffuse light around the portable battery.

3. The portable battery of claim 1, further comprising:
a plurality of electrical contacts configured to transfer electricity with a vehicle to charge the portable battery, wherein when the portable battery is secured within the vehicle via the latch, the plurality of the electrical contacts interface with corresponding contacts within the vehicle to transfer the electricity with the vehicle.

4. The portable battery of claim 3, wherein the electrical contracts are further adapted to transfer electricity with the corresponding contacts to charge the vehicle.

5. The portable battery of claim 1, further comprising:
one or more buttons for operating a light source or for disabling or enabling the one or more electrical ports.

6. The portable battery of claim 5, wherein the one or more buttons comprise one or more capacitive switches.

7. The portable battery of claim 1, further comprising:
a handle with an exterior surface of the portable battery and configured to, in response to being pulled, disengage the latch.

8. The portable battery of claim 7, wherein the latch prevents the portable battery from being disengaged based on whether a condition is satisfied.

9. The portable battery of claim 1, further comprising:
a light source configured to emit light; and
processing circuitry configured to:
receive a signal from a vehicle light controller; and
in response to receiving the signal, turn on the light source.

10. The portable battery of claim 1, further comprising:
a light source configured to emit light; and
processing circuitry configured to synchronize operation of the light source with other lights associated with the vehicle.

11. The portable battery of claim 10, wherein the processing circuitry is configured to synchronize the light emitted by the light source by one or more of changing the brightness, color, or power of the emitted light.

12. The portable battery of claim 1, further comprising:
a light source configured to emit light; and
processing circuitry configured to transmit a light source status signal to a vehicle light controller to enable synchronization of other lights associated with the vehicle based on the light source status signal.

13. The portable battery of claim 1, further comprising:
a light source; and
processing circuitry configured to synchronize operation of the light source with another portable battery or a portable speaker.

14. The portable battery of claim 1, further comprising a battery module having a capacity of at least fifty amp hours.

15. A vehicle comprising:
a vehicle;
a dock arranged within the vehicle; and
a portable battery comprising:
a latch, wherein the dock is arranged to receive the portable battery and secure the portable battery thereto via the latch;
a light source configured to emit light; and
one or more electrical ports configured to configured to provide power.

16. The vehicle of claim 15, wherein the vehicle comprises a center console and wherein the dock is arranged within the center console.

17. The vehicle of claim 15, wherein the portable battery further comprises a plurality of electrical contacts and wherein the dock comprises corresponding contacts configured to interface with the electrical contracts to transfer electricity between the vehicle and the portable battery for charging the portable battery from the vehicle or the vehicle from the portable battery.

18. The vehicle of claim 15, further comprising processing circuitry configured to synchronize operation of the light source with other lights associated with the vehicle.

19. A method, comprising:
determining, using processing circuitry, a portable battery is coupled to a dock arranged in a vehicle;
determining, using the processing circuitry, a state of charge of a vehicle battery; and
in response to determining the state of charge is low, charging the vehicle battery from the portable battery.

20. The method of claim 19, wherein the portable battery comprises:
a latch configured to secure the portable battery to the dock;
a light source configured to emit light; and
one or more electrical ports configured to configured to provide power.
